(19) United States
(12) Patent Application Publication
(10) Pub. No.: US 2008/0091676 A1
(43) Pub. Date: Apr. 17, 2008

(54) SYSTEM AND METHOD OF AUTOMATIC DATA SEARCH TO DETERMINE COMPLIANCE WITH AN INTERNATIONAL STANDARD

(75) Inventors: Martin Zwilling, Fountain Hills, AZ (US); Minh Huynh-Khanh, HoChiMinh City (VN)

Correspondence Address: GREENBERG TRAURIG, LLP (SV);IP DOCKETING, 2450 COLORADO AVENUE, SUITE 400E, SANTA MONICA, CA, 90404, US

(73) Assignee: INTELLIGENT DATA TECHNOLOGIES, INC., San Jose, CA (US)

(21) Appl. No.: 11/562,351

(22) Filed: Nov. 21, 2006

Related U.S. Application Data
(60) Provisional application No. 60/829,142, filed on Oct. 11, 2006.

(51) Int. Cl. G06F 17/30

(52) U.S. Cl. 707/6

(57) ABSTRACT

Systems and methods of automatic data search to determine compliance with international standard are disclosed here. One embodiment includes automatically searching through data of an organization for predetermined data to determine if the organization is compliant with an international standard and generating a score based on data identified from the search, the score to indicate a compliance level of the organization based on a predetermined scale of the international standard.

### BACKGROUND

The International Organization for Standardization (ISO) is a network of national standards institutes that coordinate the system to create international industrial and commercial standards (e.g., ISO standards) to meet the needs of businesses and consumer satisfaction. Adoption of international standards allows businesses to focus on product and service development to have specifications having wide usage in their sectors. International compatibility of technology and products can also be achieved in a wide range of product offerings from adoption of international standards. In addition, legislation governing health, safety, and environmental regulations can use international standards as a source for scientific background. Widely adopted international standards also allow “a level playing field” for competitors in regional and global markets, offering consumers a wide selection of products having reliable quality.

In particular, the ISO 9000 has become an international reference for quality management and execution in business processes that is applicable to any organization of various industries. The ISO 9000 includes a set of generic management system standards relevant to organizational activities related to process management. Primarily concerned with quality management, the ISO 9000 provides guidelines for the organization to enhance customer satisfaction by meeting its performance and regulatory requirements.

The ISO does not certify organizations. In fact, some countries have formed accreditation agencies to provide authorization to certification agencies to perform audit review of organizations that are seeking to ISO certification. The organization seeking ISO Certification may be assessed based on evaluation of sites, functions, products, services, processes and/or a list of problems (e.g., ‘action requests’ or ‘non-compliances’). A certificate can be issued based on an overall assessment of the organization's business processes through extensive manual analysis by an auditing agency. The assessment process is oftentimes tedious and time consuming, ultimately costly for the organization seeking the certification. Additionally, once the ISO certificate is awarded, it may need to be renewed regularly.

For example, an audit process may be conducted by auditors and includes several processes. In an initial notification stage, an auditor may request a list of documents (e.g., organizational charts, financial documents, procedural documents, etc.) from the organization for a preliminary review before onsite examination. After the initial review process, the auditor can then schedule a meeting onsite with personnel such as senior management and/or administrative staff members. Contents of discussion during this meeting may include coverage of the scope and objectives of the audit and/or any other issues that may impact the audit process such as time frame, availability of personnel, etc. The organization may also describe each unit of the organization to be reviewed, available resources (e.g., personnel, facilities, equipment, funds, off-site facilities, remote facilities, etc.), and other relevant information.

After the initial meeting, the auditor can plan the required field work including interviewing employees, reviewing procedure manuals, and/or observing operational processes, etc. For example, to obtain general overview of the operations of a particular unit of the organization, the auditor may gather relevant information through interviewing the relevant personnel, and reviewing relevant documents. In addition, the unit's internal structure may also be reviewed through gathering and analyzing information about the organization. The review may assist the auditor to determine the areas where further information is needed and to design tests that can be performed to obtain this information. Further fieldwork includes on site observations to determine if what is described in documents is properly executed at the work site. For example, specific auditing techniques may be used to test, analyze, interpret and implementation of documentation of procedure and controls to verify accuracy and propriety of execution.

As the fieldwork progresses, the auditor may periodically communicate significant findings and/or status of audit to the organization. The periodic report may also be an opportunity for the auditor to discuss possible issue points with the organization and determine methods of resolution. At the end of the audit, an audit report can be compiled which may include a distribution list of the report, a follow up date, a general overview of the organization, the scope and objectives of the audit, major audit concerns, an overall conclusion, detailed commentary of the findings and recommendations. As can be seen, throughout the duration of the auditing process, significant manpower may need to be leveraged from the auditors and from the management personnel of the organization being audited. In many instances, the auditing process is largely manual even for repetitive processes. The procedure also potentially affects normal day to day operations of the organization itself, making it more time consuming and costly.

Although certain aspects of business processes can be executed with the help of computers and software management systems, perceived startup costs, integration requirements, and training requirements may hinder the ability of smaller companies from using these same systems to automatically manage the quality documentation and process documentation such as those required for an ISO Certification (e.g., ISO 9001:2000 Certification). Thus, while computing systems may be used effectively in managing the discrete documents and unrelated applications, the ISO Certification process has continued to be conducted manually by auditors through a lengthy, expensive, and subjective procedure.

### SUMMARY OF THE DESCRIPTION

Systems and methods of automatic data search to determine compliance with an international standard are described here. Some embodiments of the present invention are summarized in this section.

One embodiment includes automatically searching through data of an organization for predetermined data to determine if the organization is compliant with an international standard.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DESCRIPTION OF THE DRAWINGS

The disclosure is illustrated by way of example and not limitation in the figures of the accompanying drawings in which like references indicate similar elements.

FIG. 1 is a block diagram illustrating a process for locating and completing an initial assessment of quality management system documentation, according to one embodiment.

FIG. 2A is a block diagram illustrating a process for assessing the documented presence and adequacy of a company quality policy in the quality management system, according to one embodiment.

FIG. 2B is a continuation of the Quality Process document assessment, to verify that the quality policy is frequently reviewed and updated for continuing suitability, according to one embodiment.

FIG. 3 is a block diagram illustrating a process for assessing the documentation and adequacy of company policy objectives in the quality management system, according to one embodiment.

FIG. 4 is a block diagram illustrating the system logic for assessing the completeness of the documented procedures indicated by the international standard, according to one embodiment.

FIG. 5 is a block diagram illustrating a process for assessing the quantity and completeness of quality records as indicated by the international standard, according to one embodiment.

FIG. 6 is a block diagram illustrating a process for assessing the mandatory documents for planning, operations, and control, as indicated by the international standard, according to one embodiment.

FIG. 7 is a block diagram illustrating a process for evaluating the extent to which available quality management documentation is appropriate to the size of the organization and type of activities carried out, according to one embodiment.

FIG. 8 is a block diagram illustrating a process for evaluating the quantity of work records related to quality management, and assessing whether these are appropriate to the complexity of processes and their interactions, according to one embodiment.

FIG. 9 is a block diagram illustrating a process for assessing the competencies and training of personnel, according to one embodiment.

FIG. 10 is a block diagram illustrating a process for preparing and presenting an ISO Readiness Index and report to requesting managers or executives, according to one embodiment.

FIG. 11 is a block diagram illustrating a process for a subroutine to verify the mandatory Quality Manual sections presence and content, according to one embodiment.

FIG. 12 is a sample report illustrating the ISO Implementation Index, explanatory comments, and an example set of recommendations and messages, according to one embodiment.

FIG. 13 is a diagram illustrating a client unit communicating with an example implementation of the ISO assessment system through a network, according to one embodiment.

FIG. 14 is an example screenshot illustrating a list of documents to be used for data search to determine if an organization is compliant with an international standard, according to one embodiment.

FIG. 15 is an example screenshot illustrating automation of an auditing process, in particular, analysis of a quality manual for conformity to ISO quality standards, according to one embodiment.

FIG. 16 is an example screenshot illustrating an ISO 9001 audit report, according to one embodiment.

### DETAILED DESCRIPTION

At least some embodiments of the disclosure relate to a method and system of automatic data search to determine compliance with an international standard.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### Overview of Audit Automation

In this disclosure, at least one embodiment includes a method and system of automation of auditing process through automatic data search to determine compliance with an international standard from documents of an organization. In one embodiment, the automatic data search may be initiated through a web-based user interface. The data search may be initiated by an employee of the organization (e.g., a management executive, a compliance manager, an audit specialist, etc.) to evaluate a current compliance level of the organization with an international standard prior to engaging in a formal audit process for preparation purposes. In addition, an auditing agency may execute the relevant data search to determine the compliance level of the organization with an international standard that the organization is seeking to obtain certification for. In one embodiment, the data search is performed for a plurality of operational processes of the organization including one or more of human resources, training management, project management, problem tracking, and/or process management.

In one embodiment, automation of the auditing process is facilitated through systematically searching for data in documents maintained by the organization to determine if adequate document management procedures are in place by comparing the data identified with a predetermined level of completeness. For example, specification of quality policies, quality objectives, and documented procedures may be indicators of document management procedures, according to the international standard. Furthermore, document management procedures and metrics of evaluating personnel competency may be subject to different levels of specifications based on the size of the organization (e.g., number of employees, number of manufacturing sites, number of research and development sites, revenue, and/or number of customers, etc.), type of activities carried out at the organization (e.g., services industry, and/or manufacturing industry, etc.), process complexity (e.g., level of supervision and review, interaction between different departments of the organization, number of people involved in a project, and/or collaboration with external organizations, etc.), according to the international standard (e.g., the ISO standard).

According to one embodiment, to determine adequacy of document management procedures and competency of personnel, data search is initially conducted to identify company characteristics and method of business such as organization size, organization activities, complexity, etc. Once company characteristics are determined, a set of specifications suitable for a particular organization may be obtained based on the international standard and compliance of document management procedures and personnel competency may be evaluated for the particular organization.

Documentation and maintenance procedures of quality records of the organization are also regulated in international standards. Quality records may include routine control and reporting documents that show progress of the quality management system including audit history, calibration of test and measuring equipment, analysis of process control data, records of corrective action, training records, etc. Quality records may be stored in a variety of forms of media, such as on paper, on CDs, and/or other electronic media. In general, quality records should be kept over a reasonable length of time and safely stored and backed up. Other records that may be retained include, management review minutes, records of education, evidence of realization processes and product fulfillment requirements, records of sales activities, design and development inputs, design and development reviews, verification, validation, and/or changes, etc. Furthermore, results of supplier evaluations, records that demonstrate validation of special processes, product identification, basis of equipment calibration, validity of measurements, results of equipment calibration and verification may be included. Auditing history results including follow up actions, indication of the person that authorizes product release, records of product nonconformities, and results of corrective/preventive actions are also included. In one embodiment, an evaluation of the quality records of the organization may be performed by initially locating the records. After the relevant records have been located, compliance of maintenance and documentation procedures with the specifications of international standards can be determined.

In another embodiment, at the conclusion of the automated data search process to determine compliance with an international standard, a report can be provided through a network (e.g., on line, intranet, internet, and/or web, etc.) to provide organization employee with evaluation information and/or an auditing agency (personnel) the results of the audit and certification process. The data search process of compliance determination may utilize a point system to represent the result of the overall assessment of compliance with an international standard. Different point systems may be used for different international standards to better represent scope and coverage of the different standards. In one embodiment, the point system can be presented as a percent scale (1-100%) where a high percentage signifies a high level of compliance with an international standard, and a low percentage indicates more work may be necessary in documenting quality standards and integrating them into the daily business operations of the organization to improve compliance level with the international standard. In one embodiment, the report may provide a listing of identified acts that can be performed to improve the readiness level of the organization to be certified by the international standard. The listing of identified acts may also serve as items to be re-evaluated during a follow up meeting after the audit.

In another embodiment, an application service provider (ASP) model may be utilized to provide remote accessibility of the compliance evaluation system to a remote client (e.g., a processing device, a computing device, a computer, a laptop, a mobile phone, a PDA, etc.) over a network (e.g., internet, LAN, WAN, etc.) to perform the automated auditing process of an organization via the remote client. In one embodiment, the remote client may be located at a site of the organization (e.g., one of the domestic or international offices, at the company headquarters, an offshore manufacturing site, a research and development site, etc.) having direct authorized access to data of the organization. In another embodiment, the remote client may be a personal computer or laptop at a company executive's personal residence.

The remote client may also be a portable computing device (e.g., a PDA, a smartphone, a BlackBerry, etc.) with which an employee of the organization or an auditing agency may use to access the compliance evaluation system. In one embodiment, access to data of the organization may be automatically given for computing devices connected on site of the organization and/or it may require user authentication. Similarly, for devices accessing data of the organization off-site for compliance evaluation, access to data of the organization may be given for a particular directory and may require user authentication. In one embodiment, using the network and the ASP model, an employee, (e.g., manager, and/or management executive, etc.) of the organization can have local access to data of the organization through user identification (e.g., password, PIN, user information, etc.) and a secure link to a remote database. In one embodiment, the database may include specifications for different international standards and tests to be applied for evaluation of compliance with each international standard.

In one aspect of the present disclosure, creation and maintenance of quality management system documentation establishes a basis for dynamic evaluation of compliance with international standards.

In another aspect of the present disclosure, integration of the compliance evaluation process is provided with operational processes of the organization, including human resources, training management, project management, problem tracking, and business process management, to determine if the quality management system documentation is appropriate to the size of organization and type of activities. These documents have a set of topics which can be addressed, including a Quality policy for the company, Quality Objectives, documented procedures as required by the ISO Standard, quality records definitions as specified by an international standard, and quality documentation for the planning process, operations process, and control process.

In another aspect of the present disclosure, a method includes generating and presenting the results of the data search to determine compliance to a requesting client (e.g., employee of the organization such as management personnel, executive personnel, audit specialist, compliance specialist, and/or an auditing agency/personnel, etc.). In one embodiment, the report can be printed and/or delivered via electronic mail to other employees. The relevant employees may carry out action items that are recommended for compliance improvement as indicated by the report The flow charts described below describe embodiments used to generate the results of the data search process to determine international standard compliance. Tests that may be applied to data obtained from the search are also described. In alternative embodiments, additional, less, or different tests and/or data searches may be included in the methods without departing from the disclosure.

### Implementation Details

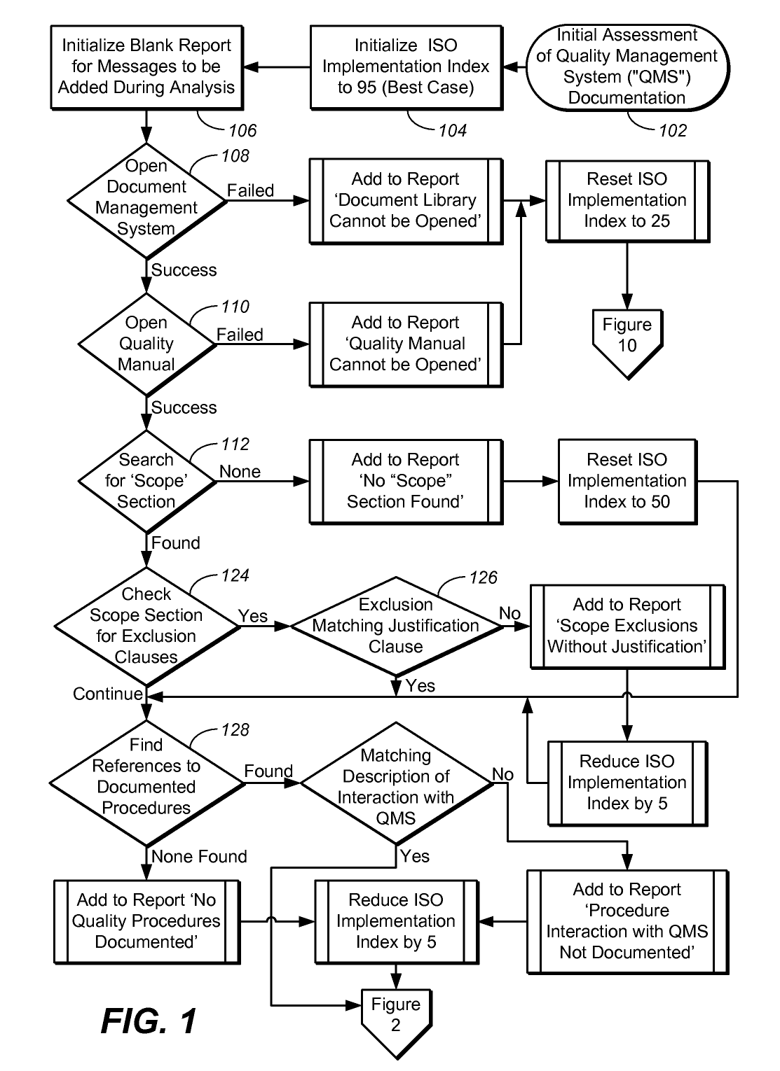

FIG. 1 is a block diagram 102 illustrating a process to perform assessment of documentation of a quality management system (“QMS”) through locating manuals and/or sections of documents that describe how the quality management system is applied to the organization, as indicated by an international standard, according to one embodiment. The quality management system refers to a portion of the organization's structure that manages the processes carried out to satisfy customer preferences, comply with regulations and/or meet environmental objectives, etc. For example, one goal of establishing a quality management system is to ensure consistency and improvement of business processes of the organization to deliver products and services suitable to customer needs. The international standard (e.g., the ISO 9000) is one of the standards that sets a framework for implementing an effective quality management system.

A document management system may be used by the organization to monitor and store electronic documents and/or images of paper documents. According to one embodiment, relevant documents such as a quality manual may be located in the document management system for analysis of the quality management system implementation of the organization. In another embodiment, the international standard may require presence of particular sections (e.g., a scope and quality section) in the quality manual. As such, the quality manual is searched for the scope and quality section as another step in determining compliance with the international standard. In one embodiment, the method may also include automatically searching through data of the organization for additional predetermined data to determine if the organization is compliant with the international standard.

In addition, an exclusion clause as indicated by the international standard allows requirements to be excluded in special circumstances. For example, under the international standard, a requirement may be excluded due to the irrelevance of the requirement to the nature of the organization and/or the irrelevance to the nature of products and services of the organization. However, to exclude the requirement according to the international standard, justification for an exclusion of the requirement should be given in the organization's quality manual. Therefore, during the search process, the justification clauses corresponding to the exclusions clauses are identified in the quality manual, according to one embodiment.

In another embodiment, a score may be generated based on data identified from the search where the score is to indicate a compliance level of the organization based on a predetermined scale (e.g., a percent scale) of the international standard. For example, the score may be deducted when the document management system cannot be accessed and/or does not exist. Furthermore, the score may also be deducted when the quality manual cannot be located and/or does not exist. Lack of particular sections and specific content in the quality manual may also result in score reduction. In one embodiment, the score is generated based on determining overall compliance level of an international standard to indicate readiness of the organization to be certified by the international standard.

For example, the score may be initiated to a 95 percentile (e.g., high score) prior to conducting the data search to set up a scoring system that can be continuously modified during the data search and analysis process, in operation 104, As the data search progresses, the score can be adjusted based on detected non-compliances or unsatisfactory implementations based on the international standard. In addition to providing the score, identified acts that can be performed to increase the readiness level to be certified by the international standard may also be provided. In one embodiment, a blank report may be initiated for messages to be added during analysis, in operation 106. For example, a note indicating a missing document could be added, or a non-compliance based on data recorded in a document (e.g., the quality manual) could also be recorded. In addition, recommendations on how non-compliances could be improved may also be documented.

In operation 108, a document management system of the organization is located and opened to search for documents (e.g., quality manual) that are indicated by the international standard as required. In one embodiment, if the document management system fails to open, the score (e.g., an ISO implementation index) may be readjusted (e.g., reset to 25 on a 100 percentile scale) to reflect the flaw and corresponding text (e.g., “document library cannot be opened”) can be added to the report. In one embodiment, the document management system is opened successfully and is searched for the quality manual in operation 110.

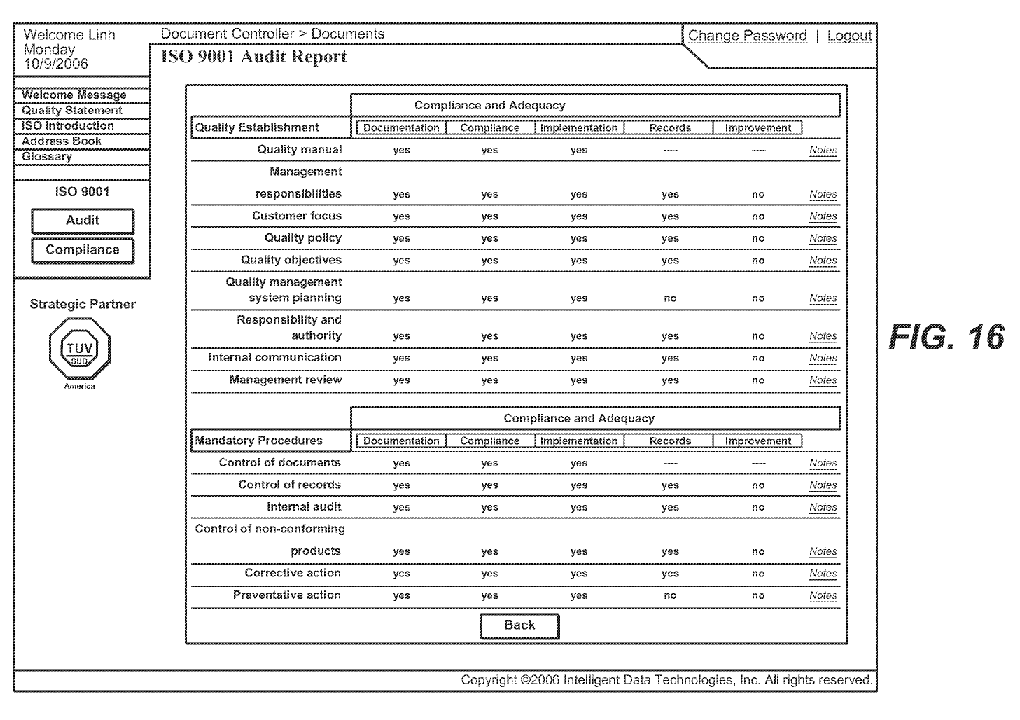

Furthermore, the quality manual should include sections such as the scope and quality policy section, according to the international standard. As such, in operation 112, the scope and quality policy is searched for in the quality manual, in one embodiment. Similarly, if the quality manual cannot be opened, and a corresponding note is added (e.g., “insufficient quality documentation and/or processes have not been implemented) to the report and the score of the ISO implementation index is readjusted, according to one embodiment. For example, in the screen shot of FIG. 16 illustrating an example ISO 9001 audit report, status of the quality manual is indicated by recording existence of the quality manual, compliance of the quality manual, and/or implementation of the quality manual, etc.

In operation 124, the scope and quality policy section of the quality manual is identified, and in operation 136 the scope and quality section is searched for required justification clauses that correspond to exclusion clauses, according to one embodiment. If the justification clauses corresponding to the exclusion clauses are not found and a note (e.g., “Scope exclusions without justification”) may be added to the report and the score is accordingly deducted (e.g., reduced by 5 percentile). In operation 128, the document management system is searched for references to documented procedures. In one embodiment, references to documented procedures are searched for in the document management system and the document management system is searched for a description of interaction of the documented procedures with the quality management system. In one embodiment, the matching description is not found and a note (e.g., “procedure interaction with quality management system not documented”) is added to the report. Additionally, if the references to documented procedures cannot be located, a note (e.g., “no quality procedures documented”) can also be added to the report and the score indicating an ISO implementation index can be reduced accordingly.

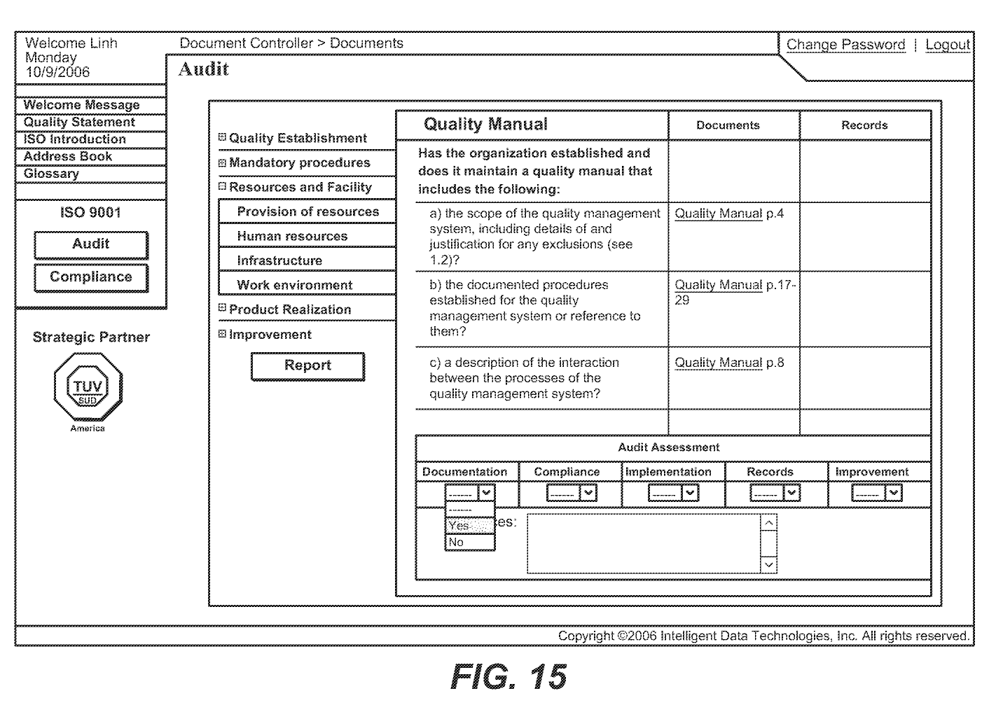

In one embodiment, a screenshot of FIG. 15 displays the details of search and analysis of the quality manual. For example, the scope section of the quality management system is determined and the details describing exclusions for specifications of the international standard and justifications for the exclusions are identified and specified to be located on p. 4 of the quality manual. Similarly, references to documented procedures are identified and indicated under the ‘Documents’ column of the screen shot to be located on p. 17 and a description of the interaction between business processes is also identified in the quality manual on p. 8, as indicated on the screen shot.

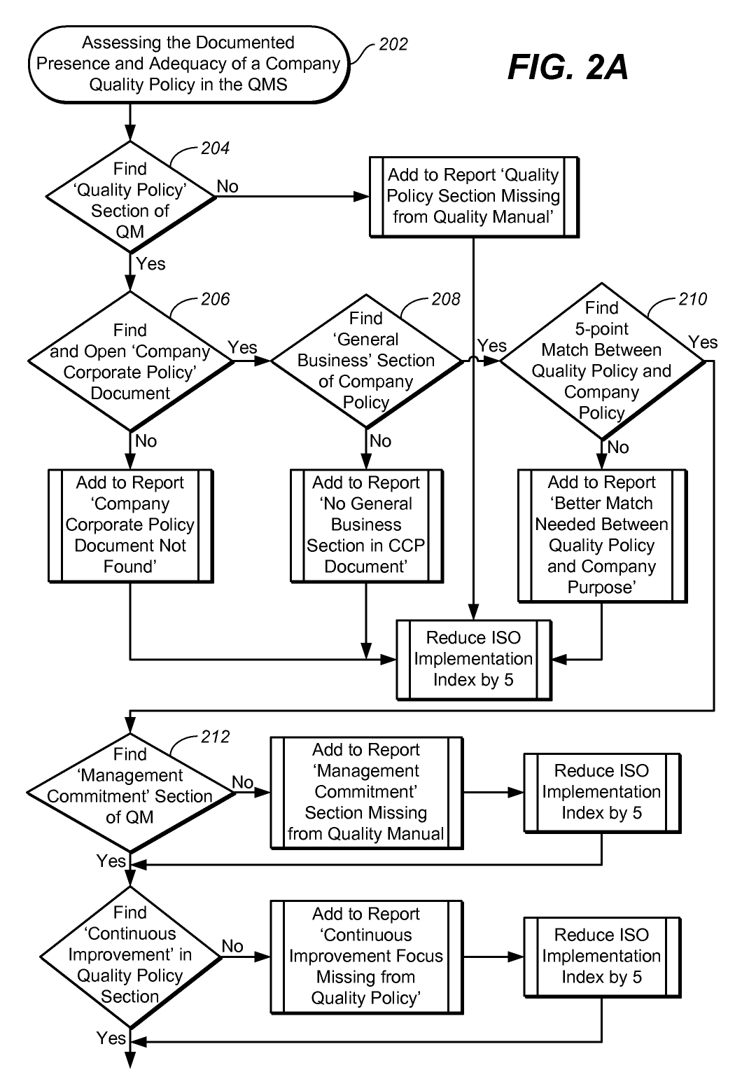

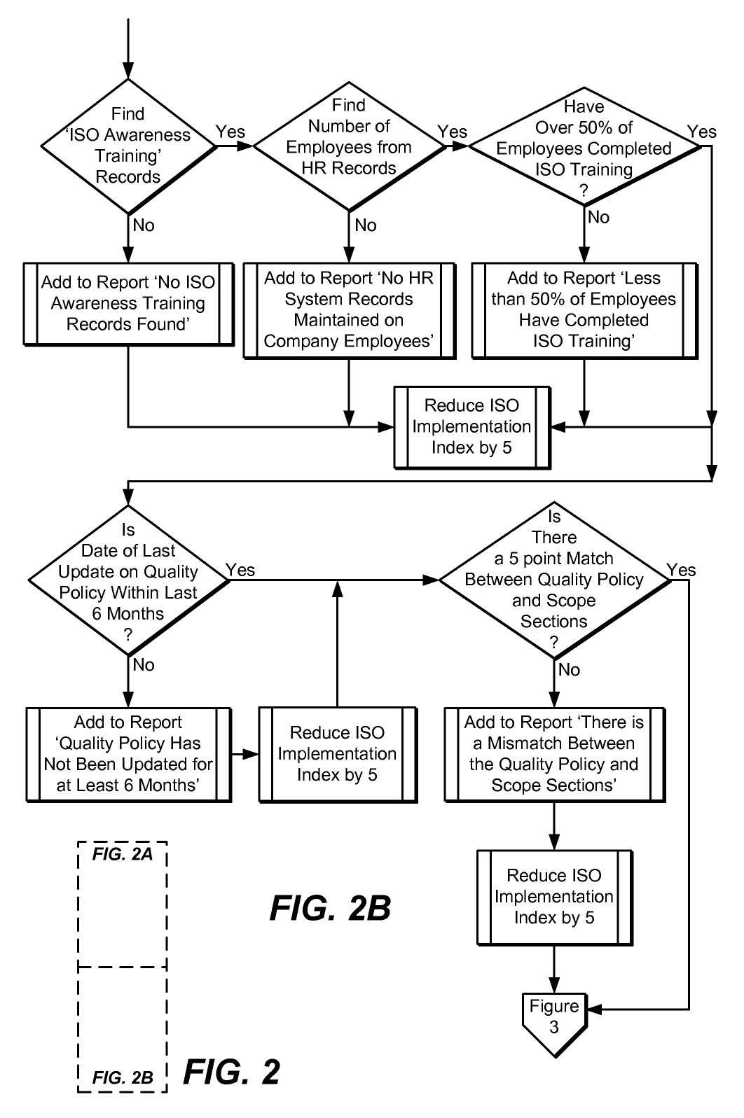

FIG. 2A is a block diagram illustrating a process 202 that searches for documentation of quality policies and determines the adequacy of the quality policies in the quality management system, according to one embodiment. One purpose of indicating quality policies is to demonstrate a devotion to following the international standard and to state the policy and philosophical goals of the organization towards implementation of each specification in the standard. In addition to describing the course of action taken by the organization to implement a particular policy, indication of rationale such as benefits and advantages behind the particular policy in place may also be stated. For example, the problem that the particular policy may solve and/or potential prevention of foreseeable issues can be indicated in the quality policies.

In general, quality policies may be defined to ensure that the purpose of the organization is properly served. Quality policies may also include indicators of commitment to complying with requirements of the international standard and specific actions for continued improvement of business process execution and management. Additionally, according to the international standard, quality policies should be communicated and understood throughout the organization for optimal implementation. Periodic review and updates of the quality policies may be beneficial to ensure applicability and suitability for the operations of the organization based on changes in business processes and/or equipment updates, etc.

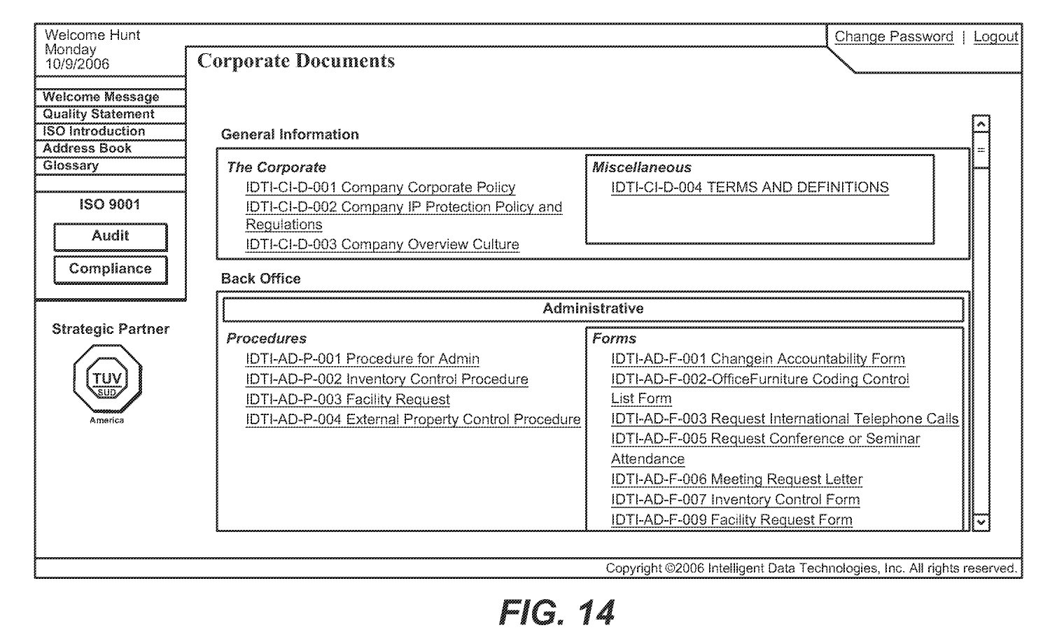

In one embodiment, the quality policy section is searched for in the quality manual in operation 204. If the quality policy and/or related sections cannot be located in the quality manual, a note (e.g., “quality policy section missing from quality manual”) may be added to the report. If the quality policy section is located, the quality policy section is searched identify a company corporate policy document, in operation 206. As shown in FIG. 14, the screen shot illustrates documentation of the organization identified during the data search. In one embodiment, the data located may be categorized into general information about the organization and back office documents. As shown under the ‘General Information’ category, the ‘Company Corporate Policy’ has been identified along with other documents such as ‘Company IP Protection Policy and Regulations’, ‘Company Overview Culture’, etc.

When the company corporate policy document is identified, it is searched to locate a general business section, in operation 208. In one embodiment, to determine whether the purpose of the organization is property served by the quality policies and to evaluate benefits of the quality policies to the organization, a point comparison can be made between the company policy and the quality policies, in operation 210.

In one embodiment, if the company corporate policy cannot be found, a corresponding recommendation can be added to the report. Similarly, if the general business section of the company corporate policy document cannot be located a corresponding recommendation can be added to the report. If an inadequate match is found between the quality policy and the company policy, a corresponding recommendation may be added to the report. In one embodiment, the final score indicating an ISO implementation index is deducted based on a predetermined percentile.

A management commitment section of the quality policy may document guidelines of continuous dedication to maintaining the international standard. In one embodiment, the management commitment section of the quality manual can be located to verify whether the quality policy includes indications of the organization's commitment to comply with specifications of the international standard, in operation 212. In another embodiment, the quality policies can be searched to determine whether the quality policies include a section that document data indicating methods to improve the effectiveness of the quality management system. For example, the data of the organization can be searched for predetermined data to determine if commitment for compliance and continuous improvement of the international standard is met. In one embodiment, if the management commitment section is not found a corresponding message is added to the report and the score of ISO implementation index is reduced by a predetermined percentile (e.g., by 5%). Similarly, if data that indicates methods to improve the effectiveness of the quality management system is not found and the message is added to the report the score of ISO implementation index may also be reduced accordingly. In one embodiment, status regarding quality policies is indicated in the screen shot as illustrated in FIG. 16 including existence of documentation, compliance of the quality policies, etc.

FIG. 2B is a flow chat describing the process of continuing the assessment of the quality policies to determine review frequency and update frequency of the quality policy, according to one embodiment.

Structures and business methods of an organization may change over time to adapt to changing consumer demands and/or industry trends. Therefore, quality policies may need to be reviewed and evaluated for relevance to the organization periodically and updated according to changes in the organization. In one embodiment, distribution of the quality policy throughout the organization can be determined through locating a training record maintained by the organization (e.g., ISO Awareness Training records) to find the total number of employees from the human resources system to confirm that at least a pre-determined number (e.g., at least 50%) of current employees have completed the training course.

In one embodiment, inadequate reviews and updates of quality policies and/or lack of distribution of the quality policies can result in recommendations for the report and reductions in the score by predetermined amounts. For example, according to an international standard, the date of last update for the quality policy document is expected to be approximately within a predetermined amount of time (e.g., the last six months) to reflect continuous update. In one embodiment, it is determined whether the date of the last update is within the predetermined amount of time (e.g., six months).

In another embodiment, if the last update was determined to be timely then the contents of the quality policy can be compared to the contents scope section on a point scale, to determine consistency within the quality management system and compliance with the international standards.

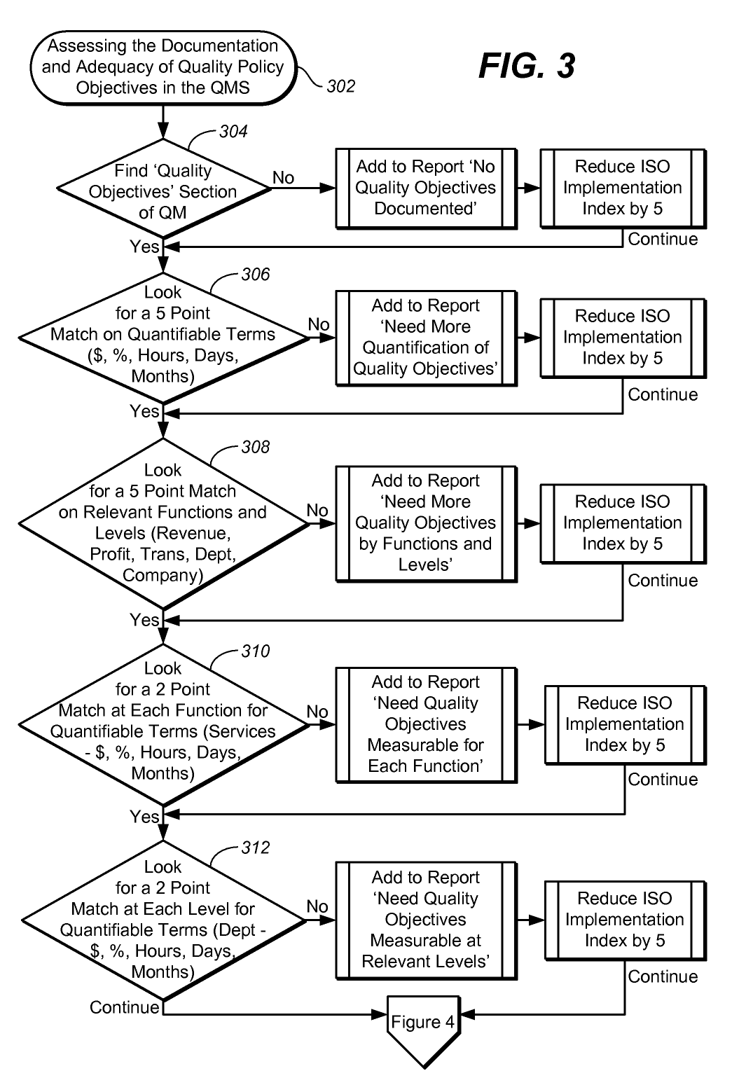

FIG. 3 is a block diagram illustrating a process 302 to determine if the documentation of quality policy objectives in the quality management system is adequate, according to one embodiment. Quality policy objectives can be constructed as measures to evaluate the performance of the quality management system of the organization and may frequently be specified in quantified terms (e.g., revenue, efficiency, billable hours, etc.). For example, quality policy objectives can be used as a framework to establish business processes and goals of the business, as well as specific tasks and milestones for achieving these goals. As such, identifying quantifiable terms in the quality policy objectives may be utilized to determine the set goals of the organization.

According to the international standard, quality policy objectives can be set for functional areas (e.g., human resources, accounting, finance, etc.) as well as hierarchical levels (e.g., project managers, executive managers, etc.) of the organization to enhance productivity to product realization. In one embodiment, the quality manual is searched for a quality objectives section, in operation 304. If the quality objectives section is not found, a corresponding note is added to the report and the score is deducted. In one embodiment, documentation of the quality objectives in the quality manual is identified. In operation 306, if documentation of the quality objectives is located in the quality manual, a point scale comparison (e.g., a 5 point match) on quantifiable terms located in the quality objectives is performed, according to one embodiment. Quantifiable terms may include, dollar amounts, percentage, hours, months, and/or days, etc, in one embodiment. If insufficient quantifiable terms are located, the score is deducted by a predetermined amount and a relevant note indicating such is added to the report, according to one embodiment. For example, documentation related to quality policy objectives may be identified in the data of the organization and searched for documentation of the quality policy objectives for quantified terms. In one embodiment, the quantified terms may be matched with a set of predetermined values on a point scale.

In operation 308, to determine if the quality objectives are established at relevant functional areas and hierarchical levels, a point scale comparison (e.g., 5 point match) can be performed on terms such as revenue, profit, transactions, department, and company to determine whether quality objectives are established in hierarchical levels and functional areas of the organization, in one embodiment. If inadequate quality policy objectives were located, a note is added to the report and the score is deducted. In another embodiment, a point scale comparison (e.g., 2 point match) can be made for the quality policy objectives at the functional areas to determine if the quality objectives are appropriately established for the functional areas, in operation 310. For example, the point scale match can be made for quantifiable terms such as dollars, percentages, days and/or months, and a set of predetermined values. Similarly, to verify if the objectives are established and measurable for a relevant hierarchical level of the organization, a point scale comparison can be performed for the level with similar quantifiable terms, in operation 312. In one embodiment, an insufficient match on the point scale and/or failure on any of these tests result in recommendations for the report and reductions in the score.

In one embodiment, status of evaluation regarding the quality policy objectives is listed in the ISO 9001 audit report as shown in the screen shot of FIG. 16. In FIG. 16, status of the quality policy objectives including their documentation, compliance level, etc. is indicated on the audit report.

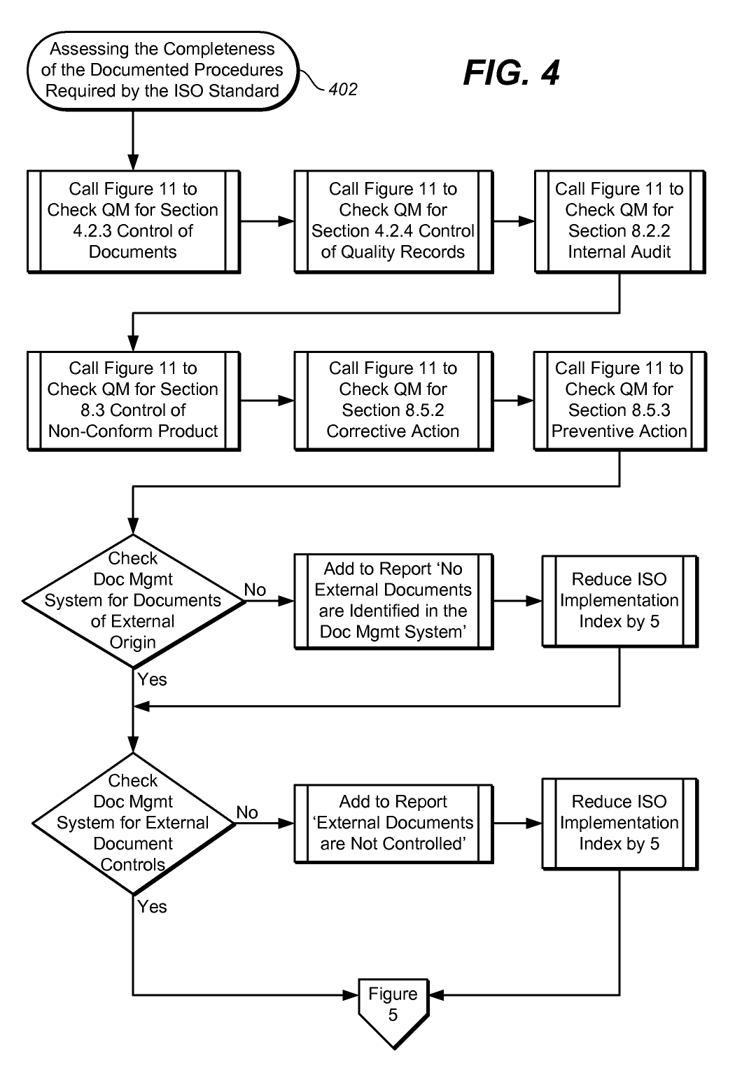

FIG. 4 is a block diagram illustrating a process 402 for determining the completeness of the documented procedures specified by an international standard, according to one embodiment. Presence of six sections in the document management system as specified by the international standard in the quality manual can be identified through searching for the clauses, “Control of Documents”, “Control of Quality Records”, “Internal Audit”, “Control of Non-Conforming Product”, “Corrective Action”, and/or “Preventive Action”.

In one embodiment, recent review and update of documented procedures is determined through identifying a recent date of access and/or update of a document and determining whether that date is within a predetermined amount of time (e.g., last 6 months). In addition, presence of revision records can also be determined by searching for predetermined data in the documented procedures that indicate version control (e.g., version 6.2.1, last updated Oct. 2, 2006). In another embodiment, applicability of the documented procedures with the business processes of the organization may be determined by performing a point scale comparison (e.g., a 5 point match) with the general business section of the company policy. In another embodiment, documents of external origin can be identified and distribution policy of documents of external origin can be determined through searching the document management system for documents having an external origin identifier. Special levels of controls for documents of external origin are also recorded during the search. In one embodiment, an insufficient match or failure on any of these checks can also result in recommendations for the report and reductions in the score of ISO Implementation Index.

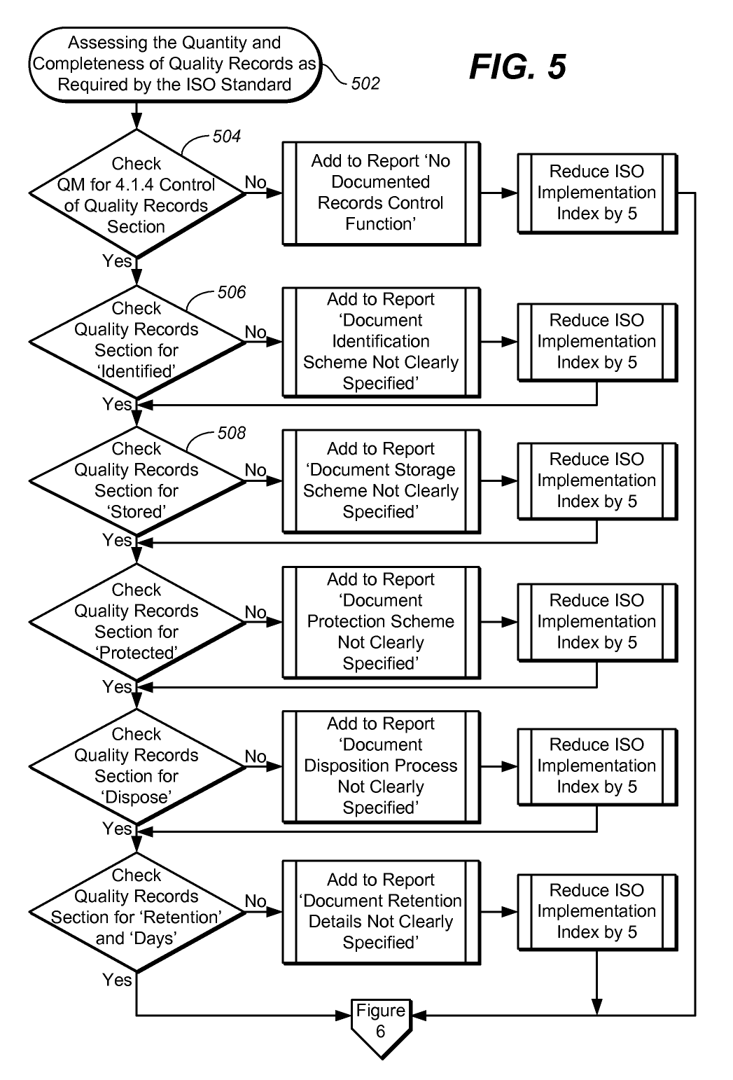

FIG. 5 is a block diagram illustrating a process 502 for determining the quantity and completeness of quality records as indicated by the international standard, according to one embodiment.

According to the international standard, quality records may include routine control and reporting documents that show progress of the quality management system including records such as audit history, calibration of test and measuring equipment, analysis of process control data, records of corrective action, and/or training records, etc. Quality records may be stored in a variety of forms of media, such as on paper, on CDs, and/or other electronic media. In general, quality records are kept over a reasonable length of time and safely stored including backup procedures. Other records that may be retained include, management review minutes, records of education, evidence of realization processes and product fulfillment requirements, records of sales activities, design and development inputs, design and development reviews, verification, validation, and changes. Furthermore, results of supplier evaluations, records that demonstrate validation of special processes, product identification, basis of equipment calibration, validity of measurements, results of equipment calibration and verification may be included. Auditing history results including follow up actions, indication of the person that authorizes product release, records of product nonconformities, and results of corrective/preventive actions are also included.

In one embodiment, a documented procedure for records control (e.g., Control of Quality Records) can be determined by searching the document management system for relevant text (e.g., control, quality records, etc.), in operation 504. In operation 506, an identification scheme to locate quality records can be determined by searching the quality records section for predetermined text (e.g., the keyword ‘identified’). In operation 508, details on how the records are stored and recorded can be determined by searching for predetermined text such as the keyword ‘stored’. In one embodiment, protection of records, authority to dispose of records, and/or retention time of records can be determined by searching for the keywords ‘protected’, ‘dispose’, and/or ‘retention’ to confirm that these topics have been covered. Additionally, the retention period in days, weeks, or months can also be located by searching the quality records for relevant text. In one embodiment, generating the score further includes identifying a records control document in the data to search the records control document for one or more predetermined data items identified in the international standard. The one or more predetermined terms include one or more keywords including identified, stored, protected, dispose, and/or retention. If there are insufficient matches and/or if failure occurs on any of these checks recommendations can be added to the report and the score is deducted accordingly.

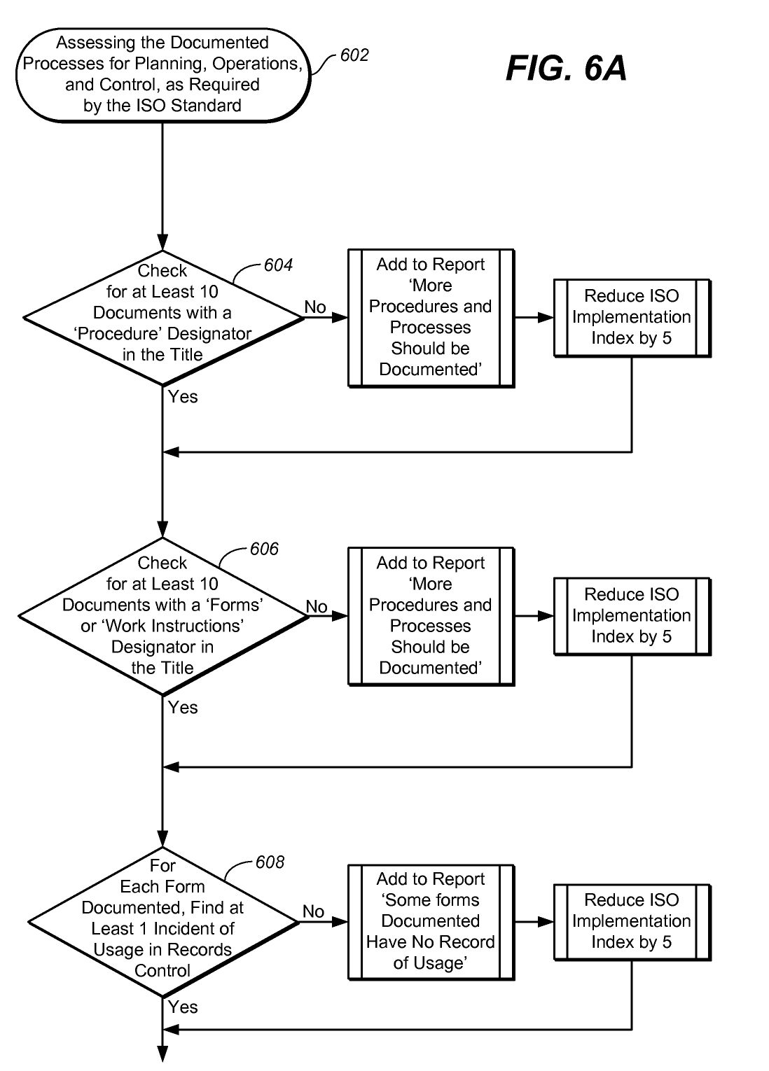

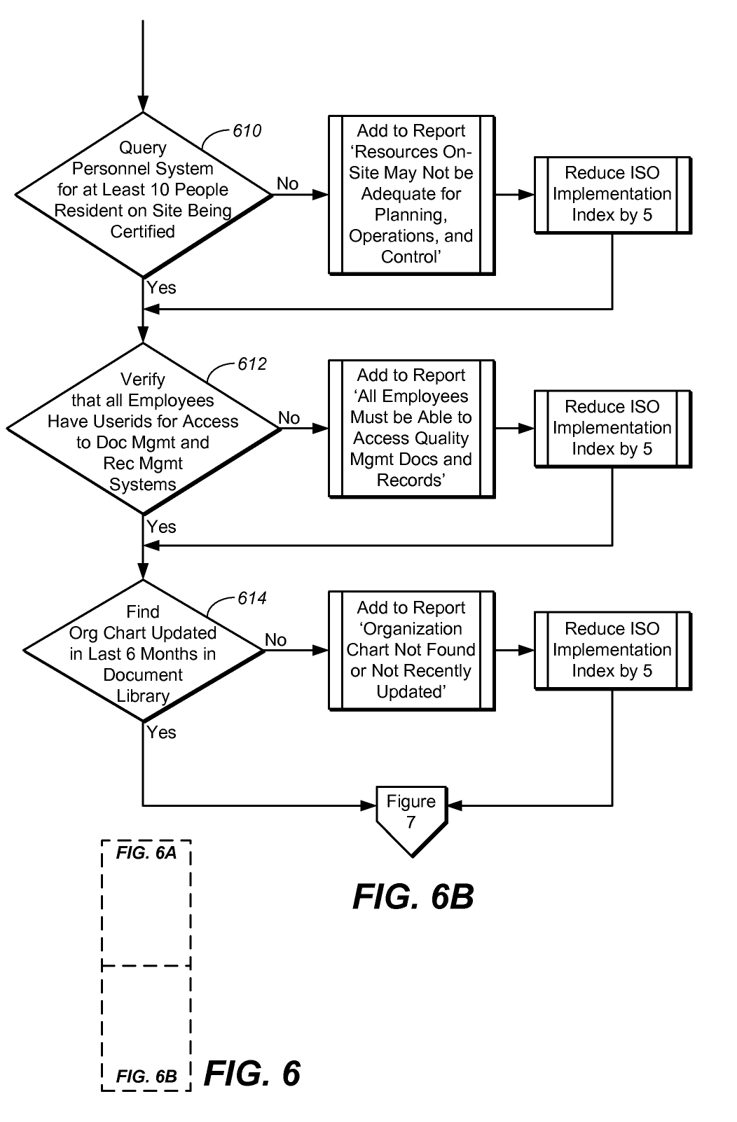

FIG. 6 is a block diagram illustrating a process 602 to determine the documents to ensure effective process planning, operation (e.g., execution of processes), and process control of the organization, as indicated by international standard, according to one embodiment.

According to the international standard, the organization shall plan and develop processes needed for product realization. In addition, the planning should be consistent with other specifications of the quality management system. The planning should also determine quality objectives and specifications of the product, the need and conditions under which to create documents (e.g., user manual, revision notes, etc.), and provide resources (e.g., manuals, technical support, etc.) specific to the product. In addition, verification, validation, monitoring, inspection, and test activities related to the product and criteria for product acceptance may also be included. Furthermore, records may also provide evidence that the product realization process and that the resulting product meet the specifications and objectives.

In operation 604, the document management system can be searched for a predetermined quantity of documents (e.g., 10 documents) with relevant text (e.g., the keyword ‘procedure’ in the title and/or file designator) to verify procedural tasks (e.g., relating to process planning and process execution) are adequately documented. In another embodiment, in operation 606, a search can be performed for a predetermined quantity of documents with relevant text such as ‘forms’ or ‘work instructions’ in the title and/or file designator. In operation 608, to determine the records related to these forms, an additional check can be made in records control for at least one completed form for form templates found. In operation 610, to verify the adequacy of on-site personnel to implement these processes, the human resources system may be queried for a predetermined number of employees (e.g., at least 10 employees) resident on the site of the organization. In one embodiment, it is verified that onsite employees have user IDs for access to the document management system and record management system to ensure that policies and objectives are widely distributed within the organization, in operation 612. In another embodiment, an organization chart is located to determine viability of the on-site organization, and the organization chart is checked for currency (e.g., update and/or access in the last six months), in operation 614. An insufficient match or failure on any of the tests result in recommendations for the report and reductions in the score of ISO Implementation Index.

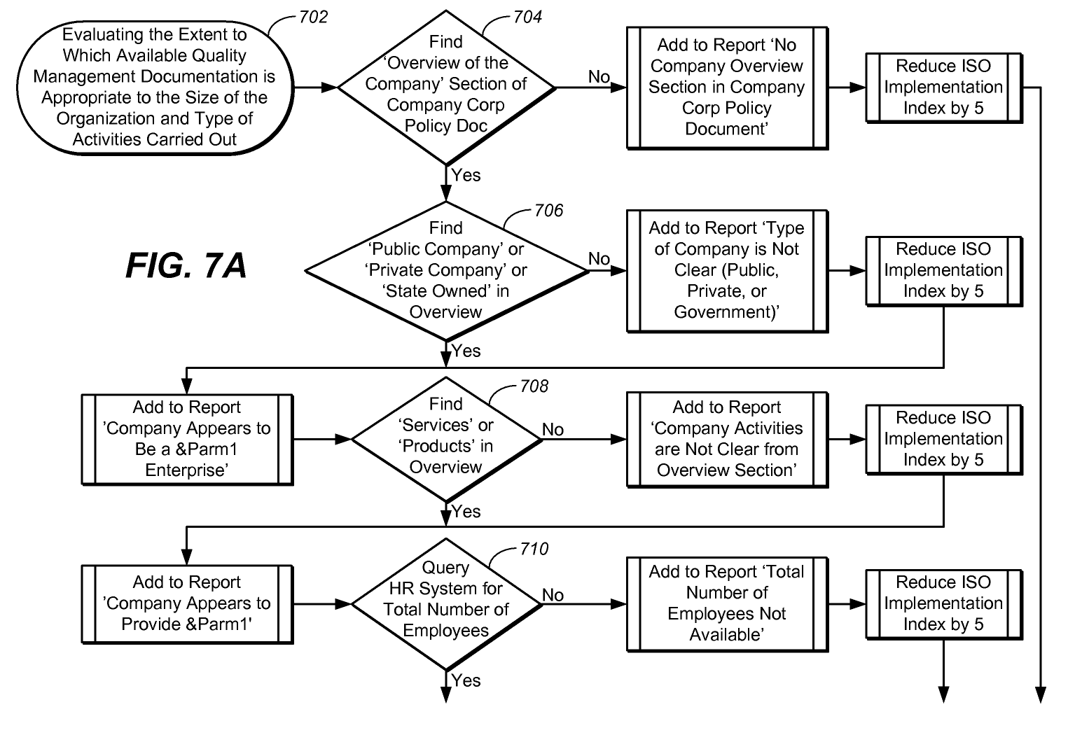

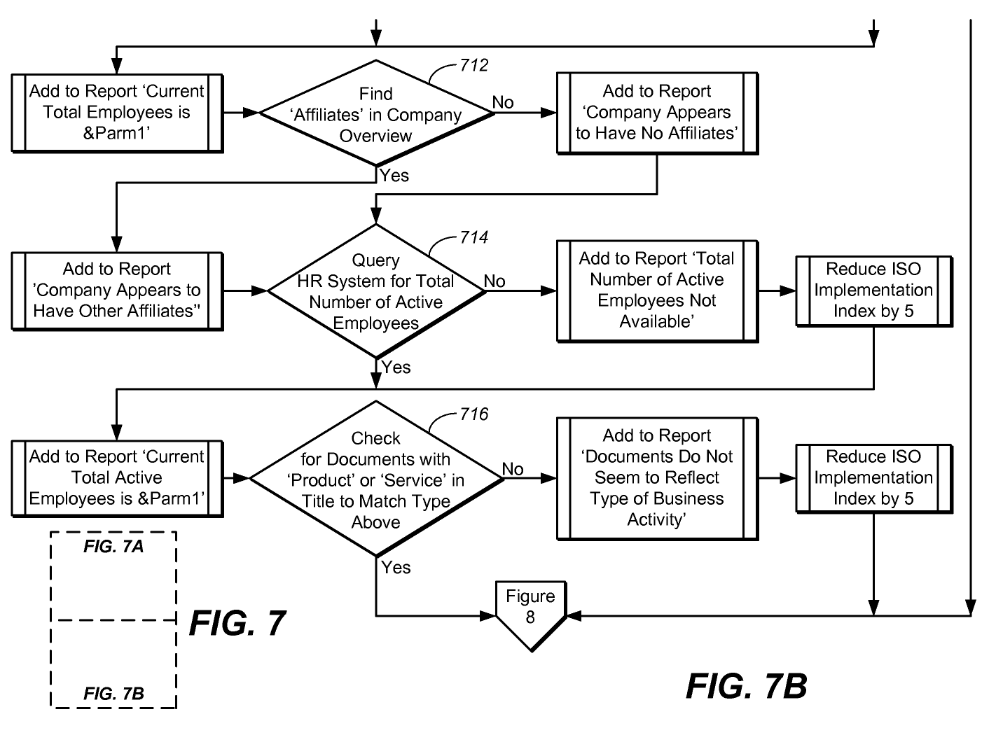

FIG. 7 is a block diagram illustrating a process 702 for determining if the quality management documentation meets a predetermined level of adequacy for the size of the organization and type of activities performed, according to one embodiment.

Since document management procedures and metrics of evaluating personnel competency may be subject to different levels of specifications based on the size of the organization (e.g., number of employees, number of manufacturing sites, number of research and development sites, revenue, and/or number of customers, etc.), type of activities performed at the organization (e.g., services industry, and/or manufacturing industry, etc.), process complexity (e.g., level of supervision and review, interaction between different departments of the organization, number of people involved in a project, and/or collaboration with external organizations, etc.), according to the international standard (e.g., the ISO standard), inherent properties of the organization may be initially determined from documents specifying overview information and/or corporate policy information of the organization prior to evaluating compliance.

In one embodiment, ownership status (e.g., public, private, or state-owned) of the organization can be determined from documents in the document management system. In operation 704, to determine the ownership information of the organization, the ‘Overview of the Company’ section of the ‘Company Corporate Policy’ document is identified. In operation 706, the company overview can be searched for predetermined keywords such as ‘public company’, ‘private company’, or ‘state owned’, etc. In addition, in operation 708, to verify the type of activities carried out at the organization, and to determine if the nature of the business is labor intensive (e.g., to determine whether the organization provides services and/or products), the ‘Overview of the Company’ can be searched for predetermined text such as ‘services’ and/or ‘products’. Furthermore, in operation 710, the human resources system can also be queried for the total number of employees to determine the size of the organization.

In operation 712 the company overview may also be searched for evidence of other activities and affiliates (e.g., collaborators) of the organization to determine complexity of the business and interactions with other organizations through searching for the word ‘affiliates’. Failures to find the predetermined keyword information can also result in decreases to the score of the final report. In another embodiment, in operation 714, to find out how many people are effectively working, another query can be made to the human resources system for the total number of active employees (e.g., employees that are not on leave or part time or retired). Then, in operation 716, a search can be made in the document management system for documents that describe the type of activity determined in operation 708 (e.g., products or services) to determine the how the business activity is executed and how its quality is being maintained based on documented procedures to delivering the products and/or services of the business operations. An insufficient match or failure on any of these checks results in recommendations for the report and reductions in the score.

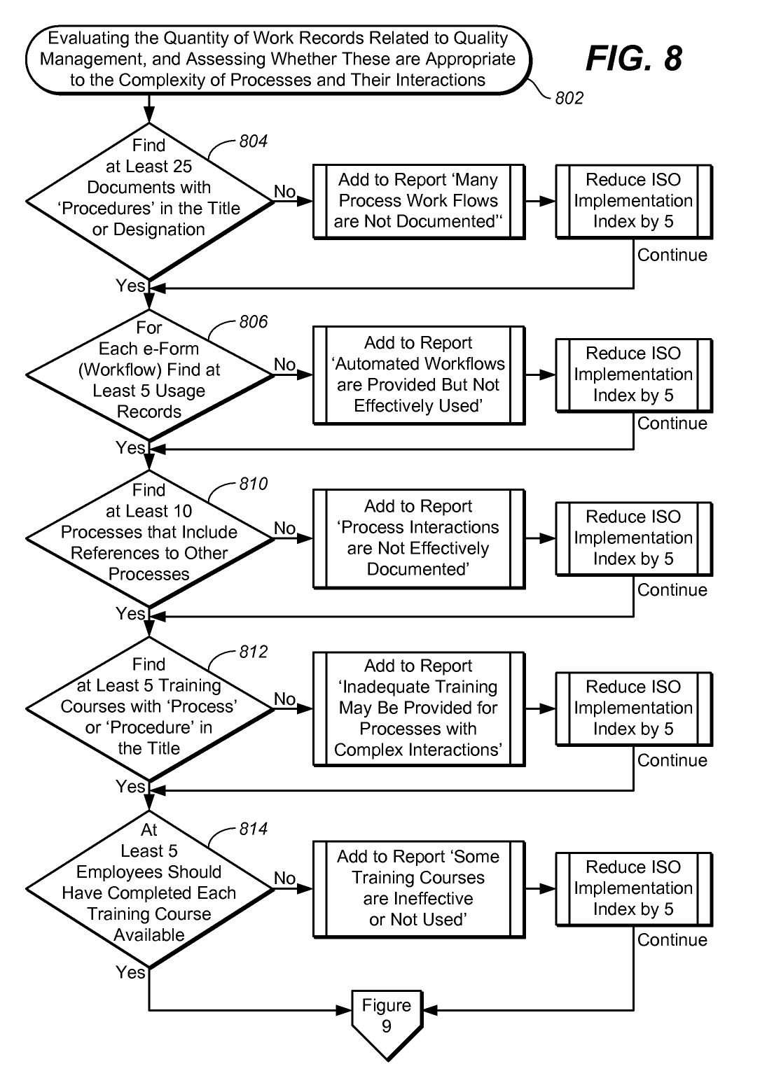

FIG. 8 is a block diagram illustrating a process 802 for identifying documented procedures for quality management and determining whether the identified procedures are adequate to the complexity of processes at the organization based on identified interactions between processes, according to one embodiment.

For example, an organization having global sites and functional sites (e.g., finance and legal, engineering, administrative sites, etc.) may necessitate long distance communication regarding joint projects. Additional processes may also govern document sharing and maintenance between sites introducing additional procedures to be documented regarding quality management.

In one embodiment, data of the organization may be searched for predetermined data that indicate organizational structure (e.g., level of complexity of the structure, number of hierarchical levels, number of employees, number of offices, number of offshore sites, etc.) and to determine whether quantitative usage of electronic forms is adequate for the organization based on the identified structure for the organization, according to the international standard. For example, a large number of documents with procedural tasks may indicate a business operation having higher complexity. According to the international standard, organizations having medium levels of complexity may be required to use automated workflows (e.g., e-Forms) to enhance efficiency in workflow management through automation. In operation 804, the document management system is initially searched for a predetermined number of documents (e.g., at least 25 documents) with ‘procedures’ in the title or designation, as an indication of a level of business complexity and interaction. In another embodiment, the identified e-Forms of the organization is listed in the example screen shot of FIG. 14 under the ‘Administrative’ category. Some example e-Forms include “Change In Accountability Form’, ‘Office Furniture Coding Control List Form’, ‘Request International Telephone Calls’, ‘Request Conference or Seminar Attendance’, and/or ‘Facility Request Form’, etc.

In operation 806, to verify if actual usage of e-Forms are as documented, the records management system can be searched for a predetermined number (e.g., 5 instances) of access of one or more e-Forms available to determine compliance for organizations having a business complexity that necessitates usage of e-Forms, in one embodiment. In operation 810, the document management system is searched to find a predefined number of documents (e.g., at least 10 process documents) having references to other processes to verify interactions. For example, interactions may be identified between a first documented process and a second documented process through locating in the first documented process a reference to the second documented process. In addition, one of the keys to effectiveness of process interactions is employee training. In another embodiment, a search is performed to find a certain number of (e.g., at least 5) training courses with ‘process’ or ‘procedure’ in the title, in operation 812. In operation 814, it is determined from reviewing one or more training records within the data of the organization if a predetermined number of (e.g., at least 5) employees have successfully completed the training courses available. An insufficient match or failure on any of these checks results in recommendations for the report and reductions in the score of the ISO Implementation Index.

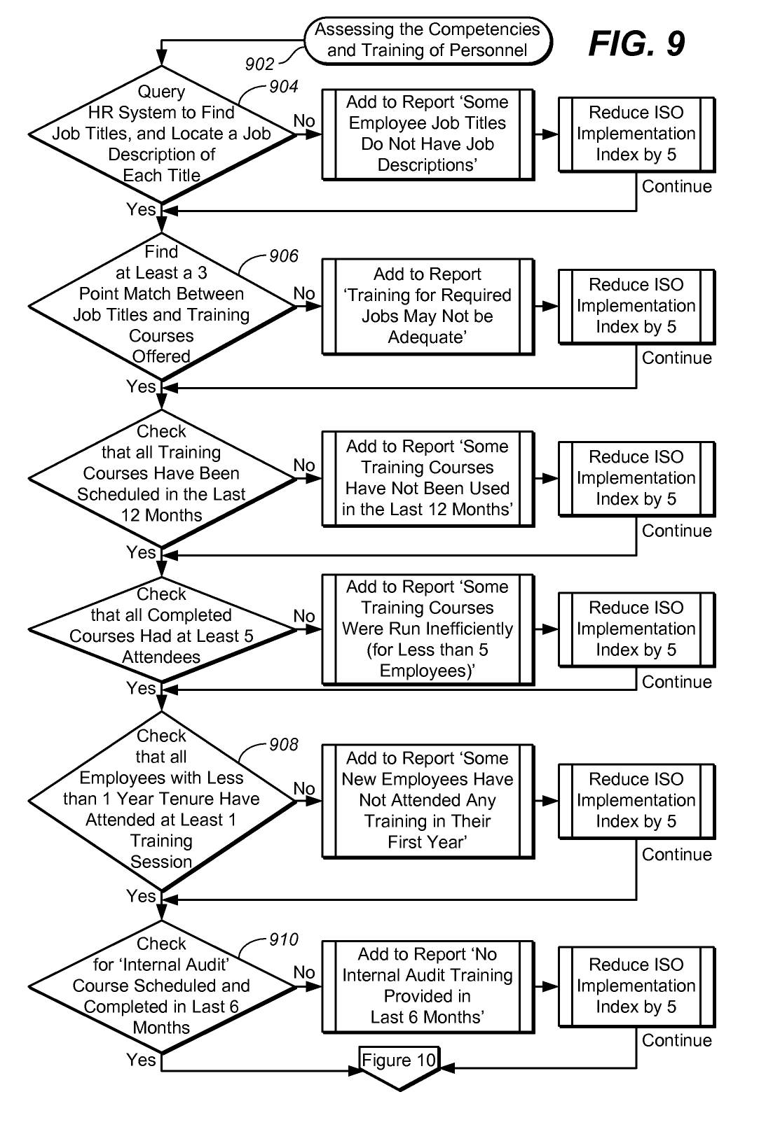

FIG. 9 is a block diagram illustrating a process 902 to determine the competency and adequacy of training of employees of the organization, according to one embodiment. In operation 904, the human resources system is queried to construct a list of active job titles in the organization, in one embodiment. In addition, a formal job description for the active job titles at the organization can also be identified in the document management system. In operation 906, to verify the adequacy of education and training for the active positions, a search is made for course titles to find a point match (e.g., at least a 3 point match) between job titles and the training courses offered. In one embodiment, the job description for the job titles of the organization can be compared with employee (e.g., resumes, past employment record, work performance, etc.) data to further determine employee competency.

In another embodiment, access records to the relevant training courses can be analyzed to determine if the training courses have been recently scheduled for new hires and/or completed by a new hire within a predetermined amount of time (e.g., in the last 12 months). In one embodiment, the number of attendees of the training course is also determined through inspecting attendance records. The number of attendees is compared with a pre-determined number of attendees (e.g., at least 5) specified by the international standard to determine compliance. In operation 908, an additional test can be performed on employees that have been employed less than a pre-determined amount of time (e.g., less than 1 year) to determine whether they have attended a training sessions to verify that new employees receive training. In one embodiment, In operation 910, internal audit training records can be determined by confirming that such a course exists, and has had a session completed recently (e.g., in the last 6 months). An insufficient match or failure on these checks results in recommendations for the report and reductions in the score of the ISO Implementation Index.

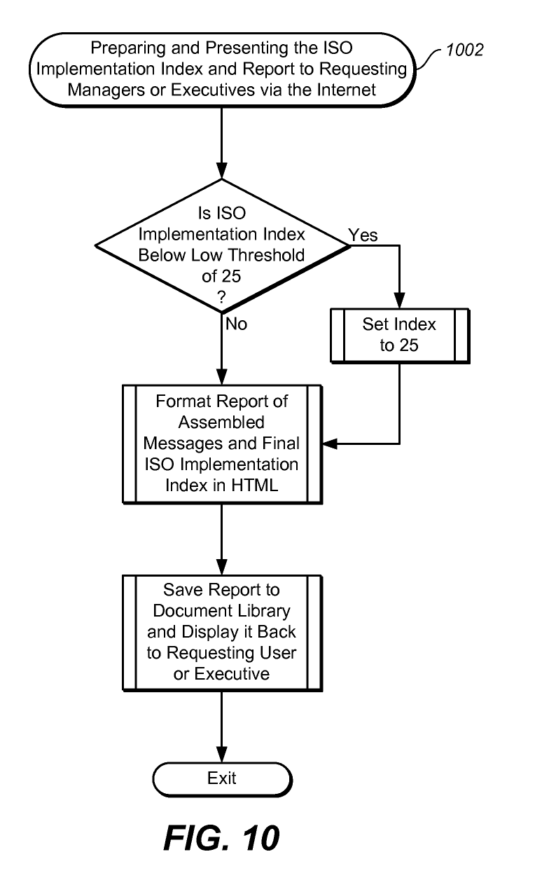

FIG. 10 is a block diagram illustrating a process 1002 to prepare a report after the data search to determine compliance of an international standard, according to one embodiment. The report may include a score to quantitatively describe overall performance on compliance with the international standard and recommendations as point of actions for the organization to improve the current overall compliance with the international standard.

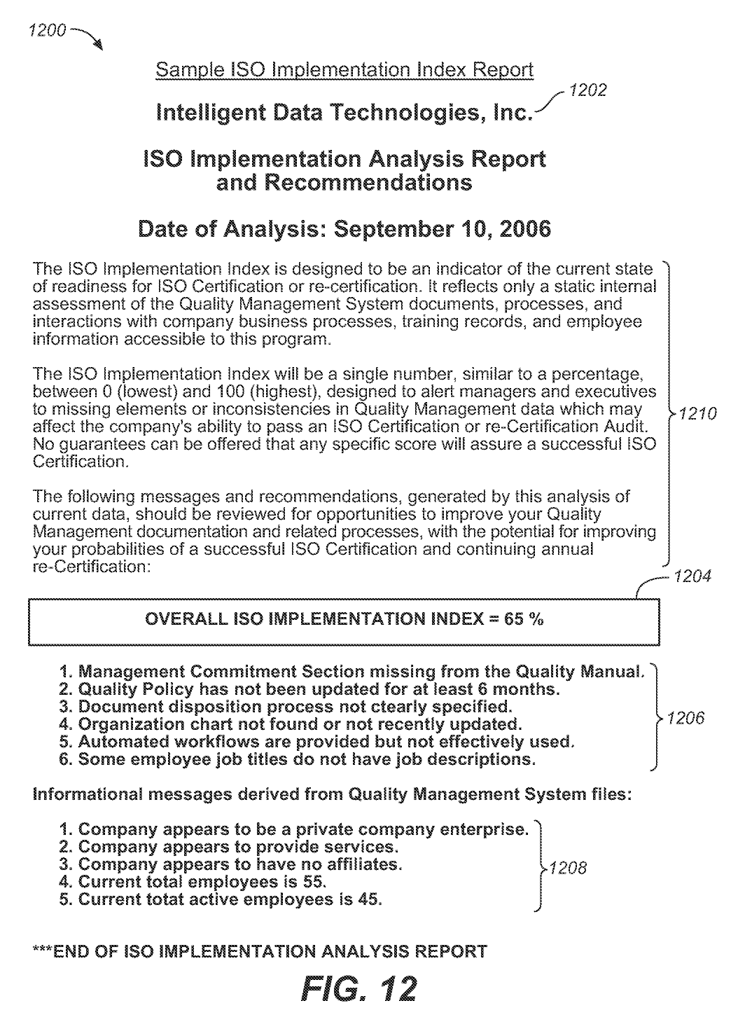

In one embodiment, the score may initially be scaled to a predetermined range on a percentile scale (e.g., between 25% to 95%). In one embodiment, if the final score is less than a predetermined level (e.g., less than 25), the score can be set to that predetermined level (e.g., 25). In another embodiment, the recommendations and/or messages regarding overview information about the organization are formatted into a single HTML report for filing into the document management system, the report can be saved and displayed back to the requesting user or executive. See FIG. 12 for an example of this report, including field definitions.

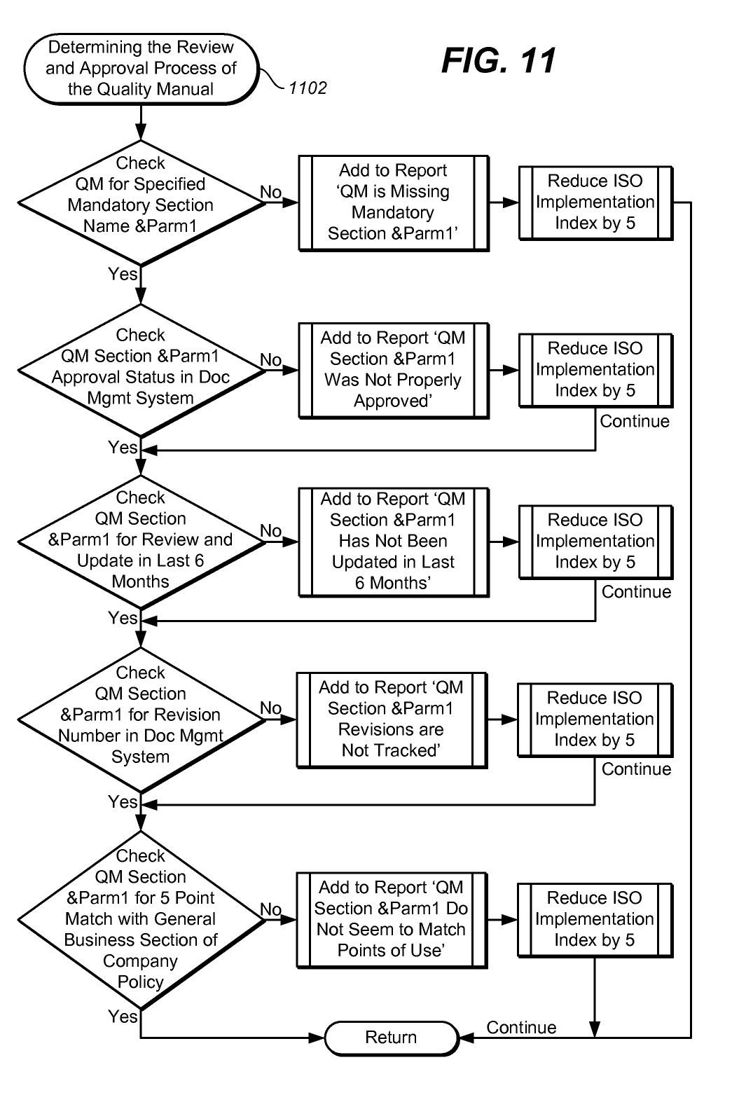

FIG. 11 is a block diagram illustrating a process to determine the presence of the quality manual, according to one embodiment. In one embodiment, the filename of the quality manual is passed as an input parameter to the subroutine (e.g., ‘Internal Audit’) to identify the quality manual in the document management system. In operation 1104, the review and approval process of the quality manual is determined from documentation and compared with guidelines of the international standard. For example, the revision process of the quality manual can be determined based on text indicating version control (e.g., presence of a version number, most recent date of access, most recent date of modification, etc.). In one embodiment, it is determined if the date of the most recent update is within a predetermined amount of time (e.g., in the last 6 months). In another embodiment, a comparison between contents of the quality manual and contents of the general business section of the company policy document is performed on a point scale (e.g. a 5 point match) to determine applicability and relevance of the quality manual to the organization and the business processes of the organization. In one embodiment, An insufficient match or failure on any of these checks result in recommendations for the report and reductions in the score of the ISO Implementation Index. The subroutine then returns control to the calling routine.

FIG. 12 is a sample report 1200 including the score indicating the ISO Implementation Index 1204, explanatory comments 1210, and an example set of recommendations and messages for compliance improvement 1206, according to one embodiment. The report includes overview information including the company name, title of the report, and date of the analysis 1202. Also included are explanations to the user about what the report represents, and how the data was generated 1210. In one embodiment, the information 1210 may also include disclaimers. In one embodiment, a text box can be included with the score to indicate the ISO Implementation Index 1204, as determined with the processes described in FIGS. 1 to 11. Below the text box can be a sample list of recommendations 1206 generated from the logic diagrams such as action items that can be carried out to improve compliance with the international standard, and a sample list of informational messages 1208 such as basic information about the organization including number of employees, ownership information, etc., For example, the sample index of 65 can be generated from an initial score of 95, less six deficiencies found (95−(6*5)=65).

### Example System View

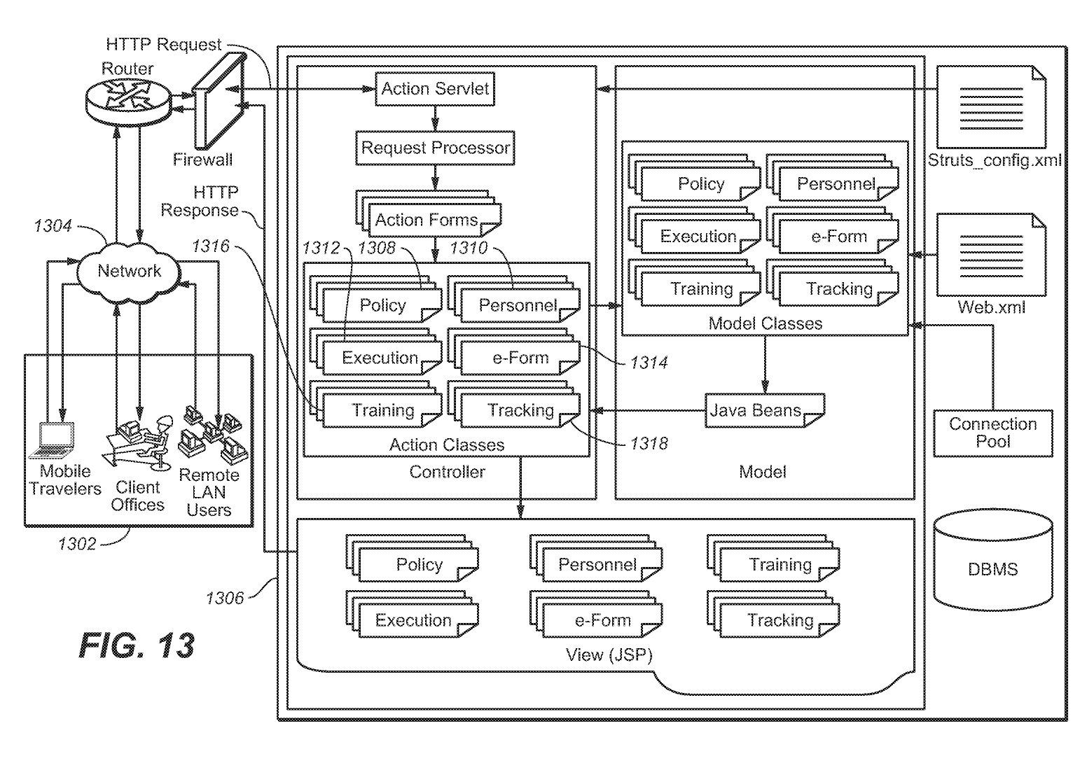

FIG. 13 is a diagram illustrating a client unit 1302 that communicates with an example implementation of an international standard assessment system 1306 (e.g., ISO assessment system) through a network 1304, according to one embodiment. The client unit 1302 may be any processing device such as a computing device, a desktop computer, a portable device, a handheld device, a computer, a portable phone, a laptop computer, etc. As illustrated, the client unit can be operated with mobile device users, users at a client office, and/or remote LAN users. In one embodiment, the mobile device user may be an auditor from an auditing agency performing data search and checks to certify an organization with the international standard. In order to access data of the organization, the auditor may need to obtain authorization through entering a user ID and password (e.g., a session specific user ID and password, an auditing agency specific user ID and password, and/or a monthly user ID and password, etc.). Access of data of the organization for an off site device may be granted for each directory as necessary or the entire document management system may be accessible.

In one embodiment, users at a client office may include employers of the organization (e.g., management executive, auditing experts, project managers, etc.) to evaluate preliminarily whether the quality management system of the organization is ready to be certified through an auditing process. As such, corrections based on the preliminary evaluation results can be made prior to the formal audit. Users at a client office may also include auditors from the auditing agency performing a data search to determine compliance of the organization with the international standard.

As shown in the figure, a request to access the ISO assessment system may be made through a network 1304 (e.g., through the internet) from a client unit 1302. In another embodiment, all or any portion of the ISO assessment system 1306 may be installed on the client unit 1302. For example, the ISO assessment system 1306 may be installed on the client unit and operated directly on the client unit. Alternatively, certain operations of the ISO assessment system 1306 may be executed through the network 1304 to access a relevant database and/or module to perform various functions of the ISO assessment system. For example, a policy module 1308 may be installed on the client unit whereas the training module may be accessed remotely through a network.

An example embodiment of the ISO assessment system may include modules to execute and manage business processes such as a policy module 1308, a personnel module 1310, an execution module 1312, an e-Forms module 1314, a training module 1316, and/or a tracking module 1318. In alternative embodiments, additional, less, or different modules may be included in the system. For example, a document module may be included to search for and identify documents for analysis. In one embodiment, the document module may search for and/or open the company document management system to find and analyze ISO standard documents such as a quality manual and documentation of quality policy in the document management system. Lack of a document management system, quality manual, and/or documentation of company quality policy may negatively affect the score indicating the ISO implementation index. In another embodiment, the document module may search a training record (e.g., an ISO awareness training record) to determine if the documented quality policy has been distributed to personnel within the organization for training purposes.

In one embodiment, documents having an external origin identifier in the document management system can be located by the document module to determine if documents having external origin are property identified and tracked in the business. Furthermore, job descriptions of active job titles in the business can be extracted from the document management system by the document module to determine adequacy of education and/or training for related jobs through a comparison of the job descriptions with employee data (e.g., resume, education records, employment records, etc.).

In one embodiment, a keyword module may operate independently and/or in conjunction with the policy module 1308 to search for predetermined data in documentation to determine compliance. For example, the keyword module may search a scope section of the quality manual for exclusion clauses and references to documented procedures, as specified by an international standard. In one embodiment, the keyword module may also be used to determine if documentation of quality objectives exists in the quality manual and to further assess adequacy of quality policy objectives in the quality management system based on business processes (e.g., type of industry, services provided, number of employees, number of sites, etc.) of the organization. In one embodiment, the quality objectives are searched for quantifiable terms such as number of dollars $, percentages, number of hours, months and/or days. In addition, verification of presence of sections specified by the ISO standard may be performed by locating ‘Control of Documents’, ‘Control of Quality records’, ‘Internal Audit’, ‘Control of Non-Conforming Product’, ‘Corrective Action’, and/or ‘Preventive Action’ documentation. In one embodiment, documented procedures for records control can also be located by the keyword module to determine the quantity and completeness of the quality records.

In one embodiment, the document management system may be searched for a certain number of documents having the word ‘procedure’ in the title or a file designator to verify focus on documented processes such as planning, operations, and/or control. Documents having the word ‘procedure’ in the title may also be located as an indication of a medium level of business complexity and interaction. According to an international standard, medium levels of complexity in an organization may necessitate the use of automated workflows and/or e-forms. To verify if the automated workflows are utilized and implemented as documented, a search of the records management system can be made by the keyword module to locate a certain number of instances of use for each e-Form that is available. In addition, to verify that that are interactions between processes, the keyword module may search the document management system to locate documents that include references to other processes. Since one of the keys to effectiveness of process interaction is employee training, a search may be performed by the keyword module to locate training courses with ‘process’ and/or ‘procedure’ in the title.

In one embodiment, the type of organization can be determined by searching the ‘Company Corporate Policy’ document for indicative keywords. To determine the type of activities of the business, the ‘Overview of the Company’ section of the ‘Company Corporate Policy’ is searched for predetermined text. The human resources system can also be queried for the total number of employees to determine the size of the organization. The ‘Overview of the Company’ section can also be searched for evidence of other activities and affiliates to determine complexity of business operations through determining collaboration with other organizations and/or other departments of the organization. In another embodiment, the ISO assessment system may also include a score module to convert compliance satisfaction of the ISO standards to a quantitative descriptor.

### Example Screenshots

FIG. 14 is an example screenshot illustrating a list of documents to be used for data search to determine if an organization is compliant with an international standard, according to one embodiment. For example, corporate documents that such as those that describe company overview, IP protection, and corporate culture can be automatically located and/or manually supplied by company management running the analysis. The corporate documents may be automatically located by the document module by allowing access to the entire document management system and/or specifying a directory within which search can be conducted. In addition, administrative forms (e.g., e-Forms) such as equipment request, facility request, accounting requests, can also be located for analysis to determine compliance, according to one embodiment. Procedural control documents such as procedures for administrators, inventory control procedures, and/or external property control procedures may also be located and displayed.

FIG. 15 is an example screenshot illustrating automation of an auditing process, in particular, details regarding analysis of a quality manual for compliance with an international standard, according to one embodiment. Key attributes of the quality manual can be located and analyzed to assess ISO compliance such as scope of quality management system, references for the documented procedures, and/or description of the interaction between processes of the quality management system. In another embodiment, the interface also shows in the ‘Documents’ column, the location (e.g., the page numbers) within which the key attributes in the documents are located (e.g., quality manual). In addition, specific records of ISO standard satisfaction can be described in the ‘Records’ column.

FIG. 16 is an example screenshot of an example ISO 9001 audit report, according to one embodiment. In one embodiment, the audit report provides a detailed report of the results of quality establishment and procedure analysis. In this example, quality establishment metrics include the quality manual, management responsibilities, customer focus, quality policy, quality management system planning, responsibility and authority, internal communication, and/or management review. The procedural metrics include control of documents, control of records, internal audits, control of non-conforming products, corrective action, and/or preventive action. In one embodiment, the audit report includes document tracking, compliance tracking, implementation, records, and need for improvement. Detailed notes on the analysis can also be provided with the audit report.

From the foregoing it will be appreciated that, although specific embodiments have been described herein for purposes of illustration, various modifications may be made without deviating from the spirit and scope. For example, adjustments or additions may be made on some of the checks described in the validation process of documents to more accurately bound the recommendations made to requesting users. Or additional messages may be generated to the report to more precisely define the current state or inconsistencies in the quality documentation and processes evaluated. Also some recommendations may have their ISO Implementation adjustment increased or decreased to facilitate better prioritization of work items by the requesting manager or executive.

In general, the routines executed to implement the embodiments of the disclosure, may be implemented as part of an operating system or a specific application, component, program, object, module or sequence of instructions referred to as “computer programs.”The computer programs typically comprise one or more instructions set at various times in various memory and storage devices in a computer, and that, when read and executed by one or more processors in a computer, cause the computer to perform operations to execute elements involving the various aspects of the disclosure. Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
automatically searching through data of an organization for predetermined data to determine if the organization is compliant with an international standard.

2. The method of claim 1 further comprising generating a score based on data identified from the search, the score to indicate a compliance level of the organization based on a predetermined scale of the international standard.

3. The method of claim 1 wherein the searching is performed for a plurality of operational processes of the organization.

4. The method of claim 2 wherein the score based on the pre-determined scale is further generated based on identifying a level of implementation of one or more international standards to indicate a readiness level of the organization to be certified by the one or more international standards.

5. The method of claim 3 wherein the plurality of operational processes comprise one or more of human resources, training management, project management, problem tracking, and process management.

6. The method of claim 4 further comprising providing identified acts to be performed to increase the readiness level of the organization to be certified by the international standard.

7. The method of claim 1 further comprising utilizing an application service provider model to provide remote access to a remote client over a network to perform the automated auditing process via the remote client.

8. The method of claim 1 wherein determining if the organization is compliant with the international standard further comprises determining if document maintenance procedures and operational processes of the organization meet one or more of a predetermined level of completeness.

9. The method of claim 8 further comprising determining ownership information of the organization and the types of activities performed at the organization by searching the data.

10. The method of claim 8 further comprising searching the data for predetermined data that indicate organizational structure and determining whether quantitative usage of electronic forms is adequate for the organization based on an identified structure of the organization.

11. The method of claim 10 further comprising identifying interactions between a first documented process and a second documented process by locating in the first documented process a reference to the second documented process.

12. The method of claim 8 further comprising identifying one or more training records within the data of the organization to determine if a predetermined number of employees have completed training of the international standard.

13. The method of claim 1 further comprising searching the data of the organization for predetermined data to determine whether commitment for compliance and commitment for continuous improvement of the international standard is met.

14. The method of claim 8 wherein the generating the score further comprises identifying documentation related to quality policy objectives in the data of the organization and searching the documentation of quality policy objectives for quantified terms.

15. The method of claim 14 further comprising matching the quantified terms with a set of predetermined values on a point scale, wherein the one or more quantified terms include one or more of an amount of money, an amount of time in hours, days, weeks, or a percentage.

16. The method of claim 1 wherein the generating the score further comprises identifying a records control document in the data to search the records control document for one or more predetermined data items identified in the international standard and wherein the one or more predetermined data items include one or more keywords comprising identified, stored, protected, dispose, or retention.

17. The method of claim 1 further comprising querying the data related to human resources to construct a list of job titles in the organization and identifying a job description for the job titles to determine whether education and training is adequate for a set of current employees based on comparing employee data with the job description.

18. The method of claim 1 wherein the international standard comprises a standard set by the International Organization for Standardization (ISO).

19. A machine readable media embodying instructions, the instructions causing a machine to perform a method, the method comprising:
automatically searching through data of an organization for predetermined data to determine if the organization is compliant with an international standard.

20. A system, comprising:
means for, automatically searching through data of an organization for predetermined data to determine if the organization is compliant with an international standard.
